(19) United States
(12) Patent Application Publication
(10) Pub. No.: US 2002/0184109 A1
(43) Pub. Date: Dec. 5, 2002

(54) Consumer interaction system

(76) Inventors: Marie Hayet, Bebington (GB); Christopher George Harbron, Bebington (GB); Shail Patel, Bebington (GB); Katharine Jane Shaw, Bebington (GB); Mohan Ravindranathan, Crawley (GB)

Correspondence Address: MORGAN LEWIS & BOCKIUS LLP, 1111 PENNSYLVANIA AVENUE NW, WASHINGTON, DC, 20004, US

(21) Appl. No.: 10/067,537

(22) Filed: Feb. 7, 2002

(30) Foreign Application Priority Data
Feb. 7, 2001 (EP) 01301098.8

(51) Int. Cl. G06F 17/60

(52) U.S. Cl. 705/26

(57) ABSTRACT

A method of efficient ordering of goods comprising the following steps:

(a) a client interacts with an electronic shopping system to indicate his willingness to place an order, whereby said interaction optionally involves the addition of further background information to the system and/or the addition of order specific information to the system;

(b) the electronic shopping system produces a suggestion of the shopping list for said client based on

(1) information concerning goods which are available for ordering, their prices and optionally further information relating to said goods; and

(2) information concerning the historic purchasing behaviour of said client; and optionally

(3) background information of said client; and optionally (4) environmental information; and

(c) said client reviews said suggestion of the shopping list and optionally amends said list followed by placing the order.

### FIELD OF INVENTION

The present invention relates to a consumer interaction system and to a method of efficient interaction with consumers for example to allow the efficient purchasing of products and/or to ensure that consumers are offered the products according to their needs.

### BACKGROUND OF THE INVENTION

Recently several trends can be observed in the interface between consumer and supplier.

Firstly the Internet and other electronic means have opened the possibility for so-called electronic shopping. Several of these shopping possibilities are available for example via Amazon.com or Tesco.com. Sometimes these systems classify the consumers in several groups and make suggestions for future purchases based on this classification.

Secondly so-called in-store loyalty schemes are used more often, these systems sometimes can be used by the suppliers for monitoring the purchasing behaviour of consumers and where appropriate to offer consumers targeted special purchasing offers for example by sending rebate coupons over the post.

Electronic shopping systems normally operate with a catalogue of goods. The interactive ordering process involves the scrolling or searching of said catalogue by the consumer followed by the selection of the goods to the ordered and the placement of the order. The supplier can then process the order and the good delivered to the consumer.

A problem with electronic shopping systems is that often the ordering process can the tedious and lengthy. This problem is especially apparent if multiple goods are to be ordered and/or orders are regularly to be placed. Often the ordering of extra items or the placing of a new order requires an additional scrolling of searching step in the catalogue and hence can significantly increase the time required for the ordering process. Also without physical contact with a shopping environment, shoppers may sometimes forget important items.

Similarly a problem with in-store shopping is that often the shopping process can be tedious and lengthy. Especially consumers need considerable time to either prepare a shopping list in advance or if they have no shopping list they often have inefficient shopping routes through the shop and run the risk of forgetting items which they need.

One attempt to resolve these problem(s) has resulted in providing the consumer with a list of previously purchased goods. The idea is that the consumer can then more quickly select preferred goods to be purchased from said historic list.

The present invention aims to provide a system and method for further increasing the efficiency of the customer interaction or purchasing process and/or to provide a more cost-effective system and method for customer interaction or purchasing of goods and/or to provide a higher quality of service.

The system of the invention can for example advantageously be used for the optimising the electronic e.g. internet ordering of goods. Alternatively the system of the invention can for example be used in store, whereby the system provides the client with advice for its shopping behaviour for example in the form of a suggested shopping list or even a pre-filled shopping basket.

It has now been found that the (electronic) customer interaction or purchasing process can be made more efficient and/or cost effective and/or provide a higher quality of service if the client is provided with a suggested ordering list at the beginning of the ordering or purchasing process.

The system of the invention is especially advantageous to be used in an environment where multiple goods are included in one purchase and/or where the frequency of purchase is relatively high and/or where a relatively high proportion of the purchases are so-called repeat sales.

### SUMMARY OF THE INVENTION

Accordingly in a first aspect the present invention provides a system for the production of orders for the purchasing of goods said system providing:

(a1) first storage means comprising information concerning goods which are available for ordering, optionally their prices and optionally further information relating to said goods;

(a2) second storage means comprising information concerning the historic purchasing behaviour of one or more clients

(a3) optional third storage means comprising background information of said one or more clients;

(a4) optional fourth storage means comprising environmental information; and

(b1) if said third storage means are present then optional interaction means for said one or more clients to add background information to storage means (a3);

(b2) optional interaction means for said one or more clients to add order specific information to the system; and

(c1) order prediction means which, based on the information stored in said storage means (a1-a4), optionally supplemented by the information of (b2), produces a suggestion for an order (shopping list) for said one or more clients;

(d1) optional interaction means for said one or more clients for reviewing the order of c1, optionally amending and supplementing said order and optionally placing the order.

In another embodiment the present invention relates to a method of efficient electronic production of orders for the purchasing of goods whereby the above system is used.

In a further embodiment the present invention relates to a method of efficient production of orders for the purchasing of goods comprising the following steps:

(a) a client interacts with a shopping system to indicate his willingness to purchase goods, whereby said interaction optionally involves the addition of further background information to the system and/or the addition of order specific information to the system;

(b) the shopping system produces a suggestion for the order for said client based on (1) information concerning goods which are available for ordering, optionally their prices and optionally further information relating to said goods; and (2) information concerning the historic purchasing behaviour of said client; and optionally (3) background information of said client; and optionally (4) environmental information; and

(c) said client reviews said suggestion of the order list and optionally amends said order followed by optionally placing the order.

Preferably the system of the invention is used for the electronic ordering of goods and/or for providing in-store advice to the client.

For the purpose of this invention the term goods refer to articles (such as foods, cleaning products etc) and/or services (e.g. laundering, gardening, cleaning etc).

### DETAILED DESCRIPTION OF THE INVENTION

The system and method in accordance to the invention is based on first electronic storage means containing a list of goods which can be ordered, optionally their prices and optionally further information concerning said goods. Such additional information may for example include information relating to introduction date of the goods, marketing activities e.g advertising campaigns or price actions or information concerning the situations in which the goods are normally ordered (for example some goods are more often ordered for parties or special occasions) or information concerning the type of consumers specially interested in said goods (for example some goods are typically ordered by families with children, other goods are for “adventurous consumers” etc).

The system and method according to the invention also includes second electronic storage means with information concerning the historic purchasing behaviour of client(s). Such information may in its simplest form be a list of previously ordered goods whereby for each good an indication is given when it has been ordered in which amount. Optionally further information may be added about special circumstances. Such information may for example in simplified form be as indicated in table 1.

Table 1 shows the amount of the goods X1-X5 that a client ordered over a number of successive interactions with the supplier.

Also the system of the invention optionally includes third electronic storage means comprising background information concerning the client (e.g. table 1 indicated that the order on Sep. 9, 2000 was close to a birthday party) but also optionally fourth storage means including environmental background information (e.g. table 1 indicates that the orders on Aug. 1, 2000 and Sep. 29, 2000 were close to a football final and a test-match) also optionally additional information about the goods can be stored for example about special marketing activities (e.g. table 1 indicates that good X3 was ordered during a price reduction or about new product introductions (e.g. table 1 indicates that goods X4 and X5 were first ordered when they were first made available in the shop).

TABLE 1

| | Amount of Goods | | | | | |
|---|---|---|---|---|---|---|
| Ordered | | | | | | |
| Date | X1 | X2 | X3 | X4 | X5 | Special Circumstances |
| Aug. 1,2000 | 1 | 2 | 1 | 0 | 0 | Day Before Football |
| | | | | | | Final |
| Aug. 6,2000 | 0 | 0 | 1 | 0 | 0 | Price Reduction on X3 |
| Aug. 13,2000 | 1 | 0 | 1 | 0 | 0 | |
| Aug. 20,2000 | 0 | 0 | 0 | 0 | 0 | |
| Aug. 30,2000 | 1 | 0 | 1 | 0 | 0 | |
| Sep. 8,2000 | 0 | 3 | 1 | 0 | 0 | Birthday Party |
| Sep. 15,2000 | 1 | 0 | 0 | 0 | 1 | Meal X5 Newly Available |
| | | | | | | in Shop |
| Sep. 20,2000 | 0 | 0 | 0 | 1 | 1 | Meal X4 Newly Available |
| | | | | | | in Shop |
| Sep. 29,2000 | 1 | 3 | 1 | 0 | 1 | Day Before Cricket Match |

The system in accordance to the invention preferably comprises third electronic storage means for storing background information of the client(s). For example the system may store information about, date of birth of the client(s), family composition, hobbies, information about (family) income, information about health (e.g. allergies), information about type of consumer (e.g. “conservative” or “adventurous”, or “vegetarian”) information of equipment available in the household (e.g. this family has a microwave, two fridges but no freezer, a washing machine and a tumble dryer and a breadbaking machine). Optional interaction means with these third storage means may allow the customer to add or amend any additional information in this storage, for example the client may indicate to the system that one of the children in the family has developed a lactose intolerance. Equally however information for said third storage means may be derived from the previous shopping behaviour (for example if the shopping behaviour shows a regular purchase of tumble dryer sheets then it is fair to assume that the household has a tumble dryer).

The system in accordance to the invention preferably further comprises fourth electronic storage means for environmental information. This information can automatically or manually be added for example based on external sources. For example environmental factors may be the weather conditions, special occasions (e.g. sports-events, television shows, special activities), consumer trends (e.g. “high income families tend to increase their use of olive oil in the kitchen” or “young families more and more use powdered milk for their babies over 3 months old” etc) health conditions (e.g. “this week about 85% of families have at least one person with the flu”). Environmental factors may also be marketing activities for example an extensive advertising campaign to increase the use of energy saving lamps or a general price-increase for oil based products.

The system of the invention preferably comprises preferably electronic interaction means whereby a consumer can amend their background information or indicate special wishes concerning future orders. For example people can indicate factors like “I have joined a sports-club” (possibly implying the need for regular ordering of sportsdrinks) “I have quit smoking” or “I will be on holiday for the next three weeks”. Also this information can relate to incidental occasions for example “I will have 4 visitors this weekend” or “I have a birthday party next week” or “I want a quick meal today”. Preferably this interaction means is used prior to placing the order such that the suggested shopping list can take the changes in background information into account.

The above mentioned storage means (A1-A4) can take any suitable form. Preferably the storage means will be in electronic form such as computer memories, discs, dvds etc. The storage means may optionally be linked to external information for example in-store loyalty cards.

Interaction means for use in a system according to the invention may be any suitable form provided said interaction means are capable of amending or supplementing the information in the (electronic) storage means. Suitable interaction systems may for example be internet based (e.g. a personal computer which via the internet can interact with the system via the interaction system to allow amendment of the storage means) or based on other communication means (e.g telephonic, WAP, SMS, interactive TV, wireless communication systems where appropriate supplemented with voice recognition tools) or via a centralised input device such as for example a computer in the store. Preferably the storage means are electronic storage means and the communication involves the internet.

The interaction means may also be linked to other input devices for monitoring the needs of customers. For example the interaction means may be connected to in-house monitoring devices of goods which are available in an house-hold, for example a household may have bar-code readers for monitoring the stored goods or may have electronic monitoring systems e.g. in a refrigerator.

The system of the invention involves order prediction means for providing a suggestion of a order (shopping list). This suggestion will be based on the information available in the above mentioned storage means. Starting point for the suggested order will be information on historic purchasing behaviour combined with information on available goods optionally supplemented by environmental information and/or background information relating to the client.

Optionally the suggested order may comprise two or more different sub-lists. For example the suggested order may comprise a “predicted list” of the goods which have previously been purchased by the client and are likely to be purchased again based on previous shopping behaviour. Additionally the suggested order may comprise “suggested list” of goods which although they are not included in the predicted list may still be attractive to this client for example because these fit in the clients life-style and/or are favourably priced and/or are related to environmental factors (e.g. an offer for Christmas decoration somewhere mid-december).

In a further advantageous embodiment of the invention the suggested order may comprise explanations and/or recommendations for example explaining to the customer why specific goods are included on the suggested order. Optionally interaction means can then be included to allow the customer to provide feedback on these explanations and/or recommendations. This feedback can for example be used to correct the current shopping list but can also advantageously be used as background information relating to the customer and hence be included in the storage means of the system.

In a further advantageous embodiment of the invention the system in accordance to the invention can act as an intermediate between customers and suppliers. For example the storage means can include information on goods available from a number of suppliers and /or historic purchasing behaviour of the client from more than one supplier. The suggested order can then not only provide a recommendation as to what goods are suggested for purchasing, but also provide additional information e.g. “this order would be cheapest if you buy from supplier A” or “Supplier B would be able to deliver this order within 3 hours” or “your food items can best be purchased from supplier C and the non-food items from supplier D”. Such an intermediate role for the system can also result in the fact that the actual order can be placed via the system at one or more suppliers. A very advantageous embodiment of the invention relates to a system whereby the system includes information on goods from more than one supplier and the system includes means for determining the most cost effective way of ordering the goods from a selection of said one or more suppliers.

An example of a suitable method for order prediction is to employ survival analysis.

For each product which has been ordered by a client more than once the set of between-order time intervals is calculated. An appropriate parametric distribution is fitted to each set to describe the distribution of time intervals between orders of each product. From this distribution a hazard function may be calculated which measures the likelihood that the client will order a particular product given the length of time since the client last ordered that product. When the client subsequently interacts with the system to place an order, the time since last ordering for each product can be calculated. The value of the hazard function for that product at the time since last ordering can be used to estimate the likelihood that the client will wish to order that product on this occasion. Those products whose hazard functions are greater than a threshold criteria are included in the shopping basket. The products in the shopping basket may be ordered by the values of their hazard functions or by other criteria.

This method will be further illustrated with reference to table 1.

For product X1 the set of inter-ordering times are {12, 17, 15, 14} days, for product X3 the set of inter-ordering times are {5, 7, 17, 8, 21} days. Fitting Weibull curves to both of these distributions gives fitted distributions with parameters {γ=9.12, α=1.58×10¹¹} for X1 and parameters {γ=2.01, α=0.0056} for X3. From these fitted distribution a hazard function can be calculated which gives an estimated likelihood of purchasing given the since the last purchase of the product.

Hazard=γ×α×time^{γ-1}

If the client were to place an order on the Mar. 10, 2000, 4 days after the last time either X1 or X3 were ordered, then the hazard functions for X1 and X3 are 0.00001 and 0.045 respectively, so it can be estimated that it is very unlikely that the client will order product X1, but has a higher probability of ordering product X3. If the client does not order either product between the Sep. 29, 2000 and the Oct. 15, 2000, 16 days since the last time either product was ordered then the hazard functions on the Oct. 15, 2000 are 0.856 and 0.185 respectively, indicating a high likelihood of ordering product X1 and a lower, but still higher than after 4 days, likelihood of ordering product X3.

The products included in the client's suggested order could be those products whose hazard functions on the ordering date exceeded a threshold value. This threshold value may be predetermined, selected by the client or adapted by comparing the clients observed behavior with the estimated purchasing probabilities. Other types of rules may be used to determine the threshold for including a good within the shopping basket, for example, “fill the clients shopping basket so that the value of the goods does not exceed £35”.

Other factors, such as price promotions, advertising campaigns, personal information, seasonality etc. may be used to adjust the estimates of the likelihood of purchase for each of the products. These factors may also be included when modelling the distribution of inter-ordering times to estimate the distribution parameters in order to remove their effect and generate more accurate estimates.

Other distributions may be used for survival analysis, for example the exponential, gamma, logistic, lognormal and extreme value distributions or a non-parametric approach, for example using splines, may be adopted.

Other calculating methods may be used for producing the suggested order. For example logistic regression may be used where the probability of a client purchasing a product is modelled as a function of predictive variables such as the time since last purchase of the product, personal information, price promotion information etc.

Similarly a neural net may be used, with the probabilities of purchase of each product being outputs of the neural net and the dates of ordering, personal information, price promotion information etc. being the inputs to the neural net.

Other calculating methods may for example involve employing a random effects methodology. This will jointly model the behaviour of several consumers, so that the estimates of ordering probabilities for a client will be based upon a combination of information of the client's historic shopping behaviour and background and information about other consumer's behaviour and background. This may permit more robust estimates of ordering probabilities to be generated.

The calculating methods to determine the best suggested order may hence be any suitable algorithm which based on the available information in the storage means can produce a suggested order. It will be within the ability of the skilled person to determine which algorithm can best be used for the specific shopping environment.

Examples of techniques used may be one or more of:

a) calculation of mean, median or quantile values

b) regression

c) logistic regression

d) general additive modelling

e) survival analysis

f) linear time series analysis

g) non-linear time series analysis

h) neural nets

i) random effects modelling

j) genetic algorithms

k) rule based methods

l) decision tree methods

m) fuzzy logic

The prediction calculating systems may not only be used to predict the type of goods to be purchased but will also possibly provide other information e.g. recommended amounts (weight, number of units etc) and/or recommended brands and/or possible alternatives.

The suggested order or order sub-list(s) can be presented in any suitable sequence or format. Advantageously the list should be formatted such that the customer friendliness is maximised. For example the items may be sorted in accordance to their likelihood that they will be purchased and/or they may be sorted by product category and/or they may be sorted on price and/or in sublists e.g. services and articles or predictions and suggestions. In store shopping advices may for example advantageously be listed in accordance to shop-layout to facilitate fast shopping and/or the in stor shopping advices may be accompanied by an advice relating to the shopping iterenary through the shop.

The system of the invention can advantageously be used in a shopping environment where the average order includes multiple products. For example the average order includes more than 5 different products, more preferred from 10-100 different products. With these order sizes the efficiency gain by using the system of the invention is most apparent.

The system of the invention can also advantageously be used in a shopping environment where the average order frequency is relatively high. For example where the average period between orders is less than 30 days, more preferred less than 14 days, most preferred from 1-12 days. With these order frequencies it is possible to attain a high level of reliability for the predicted shopping list. This will decrease the average ordering time because less amendments to the predicted list will be needed.

The system of the invention can also advantageously be used in a shopping environment where repeated sales often occur. For example the system is very advantageous if at least 25%, more preferred more than 50%, most preferred from 75-100% of the goods to be purchased are goods which are already previously bought one or more times in a period of 12 months before the current order. For example repeated sales would be expected for more than 25, 50 or even 75% of the household goods such as foods to be purchased. While other shopping environments e.g. for music, software or books traditionally have a very low percentage of repeated sales to the same customer. Especially preferably the system of the invention is used for the electronic ordering of super-market goods such as foods, home and personal care products.

The system of invention can also advantageously be used in a shopping environment where there is a long history of the shopping behaviour of a consumer. For example where the consumer has placed in excess of 10 orders with the supplier, more preferred where the consumer has placed in excess of 20 orders with the supplier. This will permit more accurate and robust models of the client's behaviour to be developed.

Particularly advantageously the system of the invention can be applied to environments where both the average number of products per order is relatively high and the frequency of placing orders is relatively high and the percentage of repeated purchases are relatively high. Specifically the system of the invention can advantageously be used for electronic shopping of supermarket goods such as foods, drinks, cleaning products, petfood etc. and services such as cleaning, laundry, ironing, gardening etc.

1. A system for the production of orders for the purchasing of goods said system providing:
(a1) first storage means comprising information concerning goods which are available for ordering, optionally their prices and optionally further information relating to said goods;
(a2) second storage means comprising information concerning the historic purchasing behaviour of one or more clients
(a3) optional third optional storage means comprising background information of said one or more clients;
(a4) optional fourth optional storage means comprising environmental information; and
(b1) if said third storage means are present then optional interaction means for said one or more clients to add background information to storage means (a3);
(b2) optional interaction means for said one or more clients to add order specific information to the system; and
(c1) order prediction means which, based on the information stored in said storage means (a1-a4), optionally supplemented by the information of (b2), produces a suggestion of the order for said one or more clients;
(d1) optional interaction means for said one or more clients for reviewing the order of cl optionally amending and supplementing said order and placing the order,

2. A system according to claim 1 for the electronic ordering of goods.

3. A system according to claim 1 for use to provide in-store purchasing advice to clients.

4. A system according to claim 1, for the ordering of supermarket goods.

5. A system according to claim 1, wherein the prediction is performed by using one or more selected from the group of: calculation of average values, regression, logistic regression, survival analysis, time series analysis, non-linear time series analysis, neural nets, random effect models, genetic algorithms, rule based methods, decision tree models and fuzzy logic.

6. A system according to claims 1, wherein the order is presented to the client in an ordered manner, by one or more selected from the group of:
the estimated probability that the client will order the items
the average frequency with which the client orders the items
the cost of the items.

7. A system according to claim 1, wherein the shopping environment is characterised by one or more selected from the group of (1) average order sizes of multiple products (2) relatively high order frequency (3) a relatively high percentage of repeat-sales.

8. A system according to claim 1, wherein the suggested order comprises explanation or recommendations and whereby the system optionally comprises further interaction means for the customer to provide feedback.

9. A method of efficient purchasing of goods comprising the following steps:
(a) a client interacts with a shopping system to indicate his willingness to purchase goods, whereby said interaction optionally involves one or more of (a1) the addition of further background information to the system and (a2) the addition of order specific information to the system;
(b) the shopping system produces a suggestion of the order for said client based on: (b1) information concerning goods which are available for ordering, optionally their prices and optionally further information relating to said goods; and (b2) information concerning the historic purchasing behaviour of said client; and optionally (b3) background information of said client; and optionally (b4) environmental information; and
(c) said client reviews said suggestion of the order and optionally amends said order followed by optionally placing the order.

10. A method of claim 9 wherein a system according to claim 1 is used.
